(19) United States
(12) Patent Application Publication
(10) Pub. No.: US 2004/0022929 A1
(43) Pub. Date: Feb. 5, 2004

(54) One-stage process for feed and biodiesel and lubricant oil

(75) Inventor: John H. Lee, Olathe, KS (US)

Correspondence Address: John H. Lee, 1441 N Lucy Montgomery Way, Olathe, KS, 66061, US

(73) Assignee: Rigel Technology Corporation, Shawnee, KS (US)

(21) Appl. No.: 10/211,703

(22) Filed: Aug. 5, 2002

(51) Int. Cl. A23K 1/00

(52) U.S. Cl. 426/635

(57) ABSTRACT

A method for preparation of feed, biodiesel, lubricant oil and fatty oil products from agricultural materials without prior fat or oil extraction process is provided. The agricultural materials can be from animal and plant products, their byproducts and waste materials. The feed products from the process can be used as more safe nutritional ingredients for animal feed and fertilizer applications. The method is particularly advantageous because it produces esters as biodiesel and lubricant oil substitutes and feed ingredients from an one-stage process, which increases feed safety and reduces the processing cost. The deactivation process could save millions of dollars for rendering industry each year.

### BACKGROUND OF THE INVENTION

This present invention relates to a process for producing feed ingredients for use as more safe nutritional sources and esters for use as diesel fuel and lubricant oil substitutes from raw agricultural materials by an one-stage process.

Animal protein products from animal byproducts by the traditional processes have been challenged as traditional nutritional sources for animals. Mad cow disease recently is a big concern in the world because of bovine spongiform encephalopathy (BSE), which has the abnormal function. There is a ban to feed animal byproducts to animals in Europe. As a result of the action, the rendering industries in UK and Ireland are supported by their respective governments at an approximate cost of $250 millions per year. The direct cost to EU is excess of $2,000 millions per year. There are also indirect costs (Lobo, 2001, Food, 1996 and Woodgate, 1996). There is a ban to feed bovine byproducts to bovine animals in USA (FDA, 1997). There are also other animal diseases such as pork mouth-foot disease and chicken flu. More and more countries, feed companies and farmers are concerned with animal diseases. Plants also have some diseases such as mycotoxin, spore and mosaic, which are affected by factors such as contamination, moisture and temperature. The diseases have the risk for transferring to animals and man. The future for feed animals by plant sources may also have some problem for disease transfer. A big challenge in our industries is how to improve the process methods and conditions to deactivate and decontaminate disease sources for both economic and health achievements.

For animal feed applications, animal fat and vegetable oil have been energy sources for nutritional purposes for many years. Animal fat and vegetable oil after the extraction processes have been also used for making biodiesel and lubricant oil as more economically feasible substitutes. Over the years, various attempts have been made to make bidiesel and lubricant oil. A number of patents have been issued for the processes.

U.S. Pat. No. 6,281,373 discloses a process to prepare dimeric fatty acid C1-4 esters from a soybean oil condensate obtained from the deodorization of refined oil in the presence of a zinc oxide. U.S. Pat. No. 6,117,827 discloses a lubricant oil process by an ester-interchange reaction in the presence of an enzyme catalyst from fatty oils. U.S. Pat. No. 5,713,965 discloses a method to utilize inexpensive animal fats and vegetable oils to produce alky esters as alternatives or additives to automotive fuels and lubricants. U.S. Pat. No. 5,525,126 discloses a process for producing esters from a fat or oil with an alcohol and a catalyst under a high pressure. U.S. Pat. No. 4,698,186 discloses a process to prepare an esterification from fats and oils in the presence of an acidic cation exchange resin. U.S. Pat. No. 2,383,601 discloses an esterification process with alcohol in the presence of acid oils. Japanese patent 071-179882A discloses a process of improved ester interchange. Japanese patent 5-209187 discloses a process to use vegetable fatty oils into lubricant base oil.

The principle of preparing biodiesel and lubricant oil is transesterification and esterification, which are described in Organic Chemistry (Solomons, 1984). Transesterification or alcoholysis of triglycerides of vegetable oils and animal fats in the presence of an alcohol leads to the formation of fatty acid esters, which are described in U.S. Pat. No. 4,164,506 and European Pat. No. 127,104.

### DESCRIPTION OF THE INVENTION

The present invention combines above two purposes to make more safe nutritional ingredients and biodiesel and lubricant oil into an one-stage process. The raw materials are from animal and plant materials without prior oil or fat extraction processes. The combined process reduce the processing cost to produce biodiesel and lubricant oil and improve the processing conditions to provide more safe feed ingredients by the one-stage process.

Bioactive compounds in agricultural materials can be deactivated. It has been reported that bovine spongiform encephalopathy (BSE) and other bioactive compounds are deactivated after treatments with strong pH change (Rohwer, 1998, Pocchiari, 1990 and Kimberlin et al, 1983). If animal byproducts have BSE risk, animal fat also has the risk to carry BSE because BSE has small molecular weight and may not be deactivated by the normal cooking process only. Polycationic dendrimers such as polyamidoamine are used as disinfecting agents to BSE for decontaminating medical device, catheter and surgical instrument to be certified prion free (U.S. Pat. No. 6,322,802). The agents may be used for animal rendering process. Alcohols have been used for decontaminating virus, protein and other biological compounds. Hydrogen peroxide is an oxidizing and disinfectant agent for decontamination, which also improves the product smell and color. Dissolved ozone is another highly efficient disinfectant agent. Pressure cookers are often used to deactivate biological compounds. The processing conditions with pH change, alcohol, heat and some disinfecting agents may be used to deactivate disease transfer. The deactivation process could save millions of dollars for rendering industry each year.

Alcohol, pH change, enzyme, disinfecting agent, heat and other conditions are involved in the process in this invention. When the esters are prepared for the ester oil production, the remaining feed materials are also exposed in the conditions for making more safe feed ingredients. The feed ingredients and biodiesel and lubricant oil are processed by the one-stage process.

Animal and plant materials with fat, protein and carbohydrate compounds can be used in the process. Besides normal animal and plant materials, their byproducts or waste materials can also be processed by this method in this invention. Such as DAF skimmings is a waste material from dissolved air flotation (DAF) units for waste water treatment with high fat and protein levels. Corn products may have high carbohydrate and fat levels. Additional alcohols with carbon atoms 1 to 5 may be added into the process. Alcohols and fatty acids may be produced from the same material such as the carbohydrate and fat in corn products. If alcohol is not involved in the process, both feed ingredients and fatty oils with high free fatty acid level are produced. The fatty oils can be used for making biodiesel and lubricant oil and other purposes. It has been found that fatty oil ingredients with free fatty acid level more than 10% on a dry basis can form complex products with animal or plant protein ingredients by a simple cooking process. The products should have the similar functions with the products described in U.S. Pat. No. 6,229,031, U.S. Pat. No. 5,514,388, U.S. Pat. No. 5,496,572, U.S. Pat. No. 4,217,310 and U.S. Pat. No. 4,216,234. This process is more practical than the processes in above patents. The complex products have no oily physical characteristics on the product surface. One or more fat, protein and carbohydrate raw materials can be used for producing the two products—feed ingredients and oil esters.

Hydrolysis process with acid, base, catalyst or enzyme is used for producing more free fatty acids. For some materials such as sunflower seed, DAF (dissolved air flotation) skimmings, coconut and palm oil seed with high free fatty acids, complete hydrolysis process may be not necessary. Transesterification and esterification can be done with pH change, enzyme lipase and catalysts such as calcium carbonate. The feed ingredients are also processed under the same conditions. The liquid and solid products are separated by centrifuge, screen and press processes. The solid feed ingredients can be further processed by other conditions. The moisture can be reduced under heat process. Vacuum may be helpful to remove moisture quickly. The liquid containing the esters and glycerol phases can be separated by a centrifuge process. Compared with high-pressure transesterification, atmospheric transesterification may use less alcohols, lower reaction temperature and less energy. In addition, atmospheric transesterification does not require expensive pressure reactors (U.S. Pat. No. 4,698,186). The process selections depend on different situations. The produced biodiesel and lubricant oil can be further processed for separation and purification.

The present provides a practical and economic process to make biodiesel and lubricant oil and more safe feed ingredients with feasible into commercial production.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

### Feed and Ester

200 grams of chicken byproducts including skin, neck, small bone, meat tissue and leftover materials were ground. 0.5 ml of sulfonic acid and 1 ml of hydrochloric acid were added to pH 3.0. The mixture was heated to 105 degree C. for 1 hour. Then 40 ml of ethyl alcohol was added under stirring. The mixture was heated to 110 degree C. for 0.5 hour. The liquid and solid were separated into two phases by a centrifuge process. The liquid was heated to 110 degree C. for 1 hour and set overnight at room temperature. The ester oil phase was obtained after a centrifuge process.

### EXAMPLE 2

### Feed and Ester

200 grams of chicken byproducts including skin, neck, small bone, meat tissue and leftover materials were ground and heated to 110 degree C. for 1 hour. 0.25 ml of sulfonic acid and 1 ml of hydrochloric acid were added and stirred for 0.5 hour. The oil and solid were separated into two phases by a centrifuge process. The oil phase was mixed with 20 ml of methanol and 0.1 ml of sulfonic acid. The mixture was heated to 110 degree C. for 2 hours. After setting overnight at room temperature, the product was centrifuged. The clear ester oil phase was obtained.

### EXAMPLE 3

### DAF Skimmings

100 grams of chicken DAF skimmings from dissolved air flotation unit was heated to 80 degree C. 1 ml of hydrogen peroxide (30%) was added under the mixing. Then the material was heated to 98 degree C. Three phases of fat, clear solution and solid were separated by a centrifuge process. The fat phase was the upper phase, which was withdrawn. The clear solution was discarded. The solid phase was dried in an oven at 100 degree C. for 5 hours.

### EXAMPLE 4

### Corn Alcohol and Fat

The corn alcohol materials including solid, alcohol, fat and water from a corn alcohol process were screened with # 80 mesh. 300 ml of above liquid was mixed with 100 grams of high-fat (46%) corn germ (ground), 10 grams of hexane and 1.5 g of lipase. The pH was adjusted to 6.5. The mixtures were mixed and heated to 55 degree C. for 5 hours. Ester and solid phases were separated by a centrifuge process. The ester oil was in the upper phase, which was withdrawn.

### EXAMPLE 5

### Fat-Protein Complex

80 grams of the centrifuged solid from a corn alcohol process with solid level 49% was mixed with 40 grams of soy soap stock from a soybean oil process with solid level 50% and free fatty acid level 33% on a wet basis. The mixture had pH 6.8 and was heated and dried in an oven at 100 degree C. for 5 hours. The fat-protein complex product was formed under the heat. The dry product had no oily physical characteristics on the product surface.

### EXAMPLE 6

### Fat-Protein Complex

300 grams of turkey blood was mixed with 150 grams of an animal fat byproduct with solid level 29% and free fatty acid level 22% on a dry basis. The mixture was heated to 85 degree C. for 3 minutes. The mixture was separated into solid and liquid phases by a centrifuge process. The fat-protein complex product was the solid phase. The wet solid product was dried in an oven at 100 degree C. for 5 hours. The dry product had no oily physical characteristics on the product surface.

What is claimed is:

1. A method of preparing both feeds as safe nutritional ingredients and esters as biodiesel and lubricant oil from agricultural materials without prior fat or oil extraction process.

2. The method of claim 1 wherein the method comprises deactivating the agricultural materials, fat hydrolysis, esterification, transesterification and separation processes.

3. The method of claim 1 wherein the esterification and transesterification are done by enzyme, pH change and catalyst.

4. The method of claim 1 wherein the alcohol is from additional source consisting carbon 1 to 5 or is produced from carbohydrate source in the agricultural materials.

5. A wet or dry feed product is produced according to the method of claim 1.

6. An ester product is produced according to the method of claim 1.

7. A method of preparing both feeds as safe nutritional ingredients and oils or fatty oils with combining disinfecting agent(s) and heat from agricultural materials.

8. The method of claim 7 wherein the method comprises deactivating the agricultural materials with one or more disinfecting agents selected from the group consisting polycationic dendrimers, acids, binding proteins, bases, peroxides, conjugate, ozone, blocks, alcohols and phosphotungstic acid and its salts.

9. A wet or dry feed product is produced according to the method of claim 7.

10. An oil or fatty oil product with free fatty acids is produced according to the method of claim 7.

11. The methods of claims 1 and 7 wherein the fat hydrolysis is done by enzyme hydrolysis, pH change and catalyst.

12. The methods of claims 1 and 7 wherein the agricultural materials without prior fat or oil extraction process are selected from the group consisting animal byproducts, corn, soybean, sunflower seed, palm oil seed, cotton seed, coconut seed, peanut, canola, olive and agricultural materials.

13. The methods of claims 1 and 7 wherein the agricultural materials without prior fat or oil extraction process are selected from byproducts and waste products from food industrial processes.

14. The methods of claims 1 and 7 wherein one or more agricultural materials are used.

15. A method of preparing fat-protein complex products comprises mixing fatty oil ingredients with free fatty acids and protein ingredients and heating to above 60° C. under pH 4 to 10 to form a complex product without oily physical characteristics on the product surface.

16. The method of claim 15 wherein the fatty oil ingredients have free fatty acid levels more than 10% on a dry basis.

17. The methods of claims 15 wherein the protein ingredients are from animal and plant sources.

18. A wet or dry complex product is produced according to the method of claim 15.
